(19) United States
(12) Patent Application Publication
(10) Pub. No.: US 2026/0230530 A1
(43) Pub. Date: Aug. 6, 2026

(54) ELECTRONIC CALENDAR SYSTEM AND METHOD

(71) Applicant: THE SECRETARY OF STATE FOR FOREIGN AND COMMONWEALTH AND DEVELOPMENT AFFAIRS, London (GB)

(72) Inventors: Robert Dale, London (GB); Joe Fox, London (GB); Christopher Kershaw, London (GB); John Buckley, London (GB); Gavin Stannard, London (GB)

(21) Appl. No.: 19/140,477

(22) PCT Filed: Dec. 15, 2023
(86) PCT No.: PCT/IB2023/062760

§ 371 Date: Jun. 18, 2025

(30) Foreign Application Priority Data
Dec. 19, 2022 (GB) 2219157.1

(51) Int. Cl. H04L 67/289; G06Q 10/109; H04L 9/40

(52) U.S. Cl. CPC H04L 67/289; G06Q 10/109; H04L 63/10

(57) ABSTRACT

Electronic Calendar System and Method A system and method for accessing calendar information is described, where the calendar information is located across a network domain boundary separating a first network domain 3 and second network domain 2. The data is accessed by a user creating enquiry data at the first network domain 3 and transferring the enquiry data between the first network domain 3 and the second network domain 2 to provide a user data request. The user data request is subsequently compared to permission criteria relating to the user in the second network domain 2 to determine whether at least part of the permission criteria is met. In the case the permission criteria is met the permitted response data is retrieved and is transferred to the requester where it is displayed or otherwise represented at the first network domain 3. Importantly, the response data received by the requester is ephemeral thereby avoiding permanent storage of the response data in the first network domain 3.

The invention is in the field of cross network domain calendars, in particular to provide an improvement of reliability and security of enabling a person to access their own calendar or the calendars of others when it is/they are located in a different network domain from that where the access request is being made.

Interactive electronic calendaring systems are well known and widely used. The objective of these systems is to assist a user who, for a variety of reasons, maintains a calendar of future events containing various information about the event at entry points on the calendar which relate to the start time of the event. Other information relating to the event, for example the other attendees, the topic to be discussed, the intended duration and the location of an event is often also provided to aid the user in identifying the need from them regarding the event. The event may, for example, be a work meeting or a medical appointment.

The increase of personal computational devices has made it possible for calendar users to establish and maintain their calendars on these interactive type data processing systems. Generally, electronic calendars may comprise multi-user environments where a large number of compute environments may be generally part of a larger communication network. It is particularly common to utilise calendars associated with or in communication with an email provision e.g. The Microsoft Exchange server is a mail server and calendaring server developed to provide a cross-domain function that can be used by Microsoft Outlook. Microsoft Exchange is a commercial product, used extensively and is published outwardly given the user may be in a different network domain/security domain to the primary information store thereby requiring regular push events to ensure that the information is available all of the time for users to access. The resulting cached data has a level of granularity in its content that creates large data storage deposits including information on ‘who you are’, ‘where you are going to be’, ‘when you are going to be there’ and even ‘why you are going to be there’ if there is sufficient information in the subject line of the appointment. This may be past information, present information or future information.

There are known to be a lot of benefits relating to the tracking of our future events using electronic calendar clients, but managing separate calendar clients for different aspects of our lives e.g. work and personal can be cumbersome. It is known to merge calendars into a single calendar for ease of use in a single user interface, however in a standard consumer server the content is published outwardly and to create reliability and to optimise the user experience in terms of efficiency, information used by calendar clients are usually cached, meaning historic data is available after the time it is required and is ready to be reused at a later moment in time, offering the standard ‘sync and store’approach to the Calendar data. This cached data produces a form of archived data. Unfortunately, the cached information may not be up to date and as a result may not be in line with the current security levels.

Further, the existence of cached or archived data provides an opportunity for people of malicious intent to access current, historic and future information in respect of the user thereby allowing them to acquire information on the intended whereabouts of the user, regularity of recurring appointments and even the reason for the appointment or event—all of which could be considered sensitive, personal information. To mitigate this risk, at the extreme end of the spectrum Microsoft Exchange includes a feature for publishing free busy information externally to a lower trusted network, but this is at the expense of the sharing of useful information for a genuine meeting participant.

It is also possible for calendar data to be tampered with, and providing inaccurate data for the user leading to an unreliable user experience.

Given the need to safely view calendar information across network domain boundaries that are, for example located between a trusted network and a lesser network e.g. a medical appointments system whereby the full details of the appointment might be held on the trusted network only, there is identified a need to provide an electronic calendar that is capable of accessing and, where appropriate, combining event information from multiple user accounts located across a variety of network domains, whilst ensuring the data is never stale and protecting any personal information or data from malicious actors attempting to access or tamper with the information from the lesser trusted network domain.

In a first embodiment of the invention, there is provided a method of accessing calendar information located across a network domain boundary located between a first network domain and second network domain comprising:
transferring enquiry data between the first network domain and the second network domain to provide a user data request;
comparing at least a portion of the enquiry data to permission criteria in the second network domain to determine whether at least part of the criteria is met;
creating response data for the at least part of the criteria being met;
transferring the response data between the second network domain and the first network domain,
electronically mapping the response data into calendar information to be displayed or otherwise alerting receipt of the response data by the user located at the first network,
wherein any response data received by the user located at the first network is ephemeral.

The fact the response data received by the user located at the first network is ephemeral provides the benefit of thereby avoiding permanent storage of the response data on the first network.

This method limits the risk of data aggregation outside of the data's home security domain so as to enable the safe viewing of calendar information across security borders and to prevent data trawling by malicious actors. Any data that is outside of it's home security domain (also know as its primary security domain) is ephemeral and only used to ‘render a view’to the user and not stored.

The first and second network may have a different level of trust, and the first network may be the lesser trusted network.

Beneficially, it is only the information requested by the user that is published. So data/calendar information (response data) is retained within the second network domain until an authorised data request is made by a user located in the first network domain, and is accessible for an appropriate duration required for viewing the response data. This invention provides for a ‘pull-request’ rather than a ‘push-request’, meaning the response satisfies the authorised user data request made by the user at the first network domain. In contrast other known models push all the data from the second network to the first network—meaning the data is ‘blindly published’ i.e. includes data which is never legitimately to be viewed, meaning all data will be exposed and aggregated regardless of whether it is requested or not.

The Enquiry data is a data request for the Calendar information to be viewed by the user. The user at the first network domain may also be considered to be the requester.

Further, by publishing the event information at the time of the request the security manager at the second network maintains control of the data all of the time and there is assurance that the correct security criteria is being implemented when the calendar information is being viewed by a requester located at the first network. The requested data is only ever stored in the second network (which is considered to be the home or primary security domain). The first network may also be considered to be the foreign security domain or the secondary security domain.

Preferably wherein the first network is a trusted network and the second network is a lesser trusted network or vice versa. The invention can also work for data being passed from high security domains to low security domains and vice versa, with the same principles applied in either direction.

The response data may be disposed of once the data ceases to be displayed to the user on the first network domain.

This will be dependent on the security policy and may be configured to vary in dependence upon the requester. The security criteria, which is determined by the security policy of the second network, is evaluated every time a view request is made by the requester.

The method may further comprise data only being transferred between the second network and the first network upon a calendar information request by the user located at the first network.

The method may further comprise the response data being held in RAM and being marked as reclaimable once the response data ceases to be displayed to the user in the first network domain.

The method may further comprise electronically mapping the response data into calendar information to be displayed or otherwise received by the user located at the first network domain.

The method may further comprise the calendar information being displayed on an user display, for example an electronic user display such as a screen and the act of refreshing the user display triggering the calendar information to be cleared. The ephemeral nature of the response data and/or the calendar information requires data to be transferred many times to provide the desires security levels on each user request, which would be considered an unnecessary step by conventional systems (which have a large number of users and as mentioned previously rely on the push of data to make it easily accessible and reliable to the number of users).

The method may further comprise the response data being retrieved only for the part of the user data request where the permission criteria is met. The permission criteria may be defined by the user who owns the calendar being targeted. As mentioned previously this provides a pull-request for permitted data rather which is a better and secure way to manage data transfer.

The method may further comprise the part of the user data request where the permission criteria has not been met being discarded or ignored.

This prevents the push of unnecessary data, and reduces the aggregated data available at the first network domain.

The permission criteria defined by the user will use the request source network domain and user identity as input, and will reference rules defined by the targeted user to determine the level of information to be released to the request (for example whether to use free/busy, the event title, and/or a list of attendees).

The permission criteria checks may further comprise the step of outputting an electronic permission flag at the second network each time a user data request occurs.

The permission checks may be related to various criteria being met including location, user information, how much of the data is to be accessed, the period of time the data is to be made available on an ephemeral basis. This gives network managers at the primary network the ability to decide who across the security border has rights to see their calendar and what level of information that requester could gain access to. The permissions may therefore be set up as a high-level security policy, at a user level or in combination of these two options. Preferably, the permission criteria is a security criteria.

Enabling the meeting content can be transferred subject to the security label or Xep-258/259 email equivalent. In reality it is the security checks that will be most important when dealing with information passed across a network domain boundary. There will be a Security policy and an associated security criteria set out that is updatable and by evaluating the security policy/checks and implementing the checks at every time the calendar information is to be used this ensures that the correct security criteria is being implemented. If it is updated, and reviewed regularly there is no risk of using old, cached calendar information which is aligned with old security criteria.

The method may further comprise either the first network domain being a trusted network domain and the second network domain being a lesser trusted network domain or the first network domain being a lesser trusted network domain and the second network domain being the trusted network domain, or the first network domain and the second network domain having the same level of trust.

This offers a versatile product that can be applied in accordance with a particular user need.

The method may further comprise the first network domain and the second network domain having separate and distinct security management criteria.

This means that a security manager at the first network domain has no ability to alter the security management criteria at the second network domain. This is particularly important where the first network domain has a lesser trusted network to that of the second network domain.

The method may further comprise data solely being transferred between the second network domain and the first network domain upon a calendar information request by the user located at the first network domain.

This ensures that the targeted data that is requested also has the most up to date security criteria applied to it, both providing improved security management to e.g. a sync and store offering.

The method may further comprise collating the response data associated with the second network domain with calendar data stored on the first network domain to provide a single calendar display having both event entries from the first network domain and the second network domain. This may be achieved with the response data or the mapped calendar information as preferred.

This is beneficial to the user as all of the possible appointment from different systems are available in a single display.

The method may further comprise redacting at least part of the response data in dependence upon the pre-determined disclosure criteria.

This offers a useful safety-net between the data requested and the user authorised data.

The method may further comprise user identifier information being mapped from a first network domain identifier to a second network domain identifier and/or from a second network domain identifier to a first network domain identifier. This can be implemented for requesters, users or event attendees as desired. The mapping will be undertaken in a conventional way. This means that it is not only the Calendar data that is protected from malicious users, but information about the individual as well—e.g., attribution levels may be managed appropriately in dependence upon the settings at the first network. Therefore, the user's home identity may be mapped to an external identity—having this dual identity (one for each network) is intended to protect the home identity of the user, requested participant or an existing event participant.

Preferably, the response data may be a stream of data comprising data packets.

Preferably, the enquiry data and the user data request comprising a stream of data comprising data packets.

Alternatively, the response data comprises a stream of data comprising data packets.

The method may further comprise the enquiry data and/or the response data being transferred across the network domain boundary via a network gateway. This may be in the form of a hardware network gateway of a software network gateway. Hardware network gateways are simple yet reliable devices that can the located on the site of the e.g., trusted network domain.

The method may further comprise enquiry data being transformed from the first network domain data format to a SISL data structure prior to being passed across the network domain boundary. The SISL file may cross the network domain boundary via the network gateway. Alternative transfer of data may be realised, e.g. via cable or other known techniques.

The method may further comprise the response data being transferred from the second network domain file format to a SISL data structure prior to crossing the network domain boundary. Beneficially, the response data may be transferred across the network domain boundary via the network gateway.

The method may further comprise the first network domain data format and/or the second network domain data format being JSON, XML or CSV. Other structured data formats known in the art may be used as an alternative.

The method may further comprise the data transferred across the network domain boundary being devoid of contextual information. This ensures that the content of the message is completely standalone, meaning that extraction by a malicious actor reaps no rewards. The transfer of data may between the first and second network domains or between the second and first network domains.

The method may further comprise the number of data enquiries from a user being rate limited dependent upon the identity of the user. Beneficially, this may be achieved by rate limiting the transfer of enquiry data from a user dependent upon the identity of the user.

The rate limit is provided to ensure that the requests are coming from a normal non-machine. This gives a low-level validation of a genuine requests by mitigating the risk of large-scale data mining. Machine learning techniques may be implemented to ascertain the regularity of requests from an individual, for example it may be appropriate to set the rate limit to 3 queries per hour, although a Personal Assistant or other individual responsible for setting up multiple meeting as part of their role, may require a higher rate limit.

Beneficially the user may select the meeting subject from a predetermined list of meeting/appointment type entries. Where a meeting subject to be used is not included in the explicit list, then the meeting subject may be redacted when the event is displayed on the first network. Similarly, wherein where a meeting location to be used is not included in the explicit list, then the meeting location is redacted when the event is displayed on the first network.

The method may further comprise redacting at least part of the information response in dependence upon the determined security status criteria of the requester.

In the case it is determined that the requester fails the permission criteria check either no data may be sent in response to the request, or dummy data may be sent as a response to the request. In the case that it is determined that the requester only has permission to view a portion of the Calendar data request, then the portion that they do not have permission to access will be redacted. Therefore, the requested will only be allowed to view part of the total event information available on the second network. Therefore, the system enables a user located in a different security domain to see an appropriately redacted view of either their own or other peoples' calendars, subject to permission.

The way or format the data is requested may in itself be a determining factor on the permission criteria output.

In an alternative embodiment of the invention, there is provided a cross network domain Calendar system for use with a user terminal, having a user display, the user terminal being located at a first network domain comprising:
a first processing means located at the first network domain configured to, in use, generate a user data request to access Calendar data located at a second network domain,
a second processing means located at the second network domain and configured to receive the user data request, retrieve response data and transfer the response data across a network domain boundary for receipt in the first network domain, such that the response data is displayed or otherwise represented via the user display, wherein the response data at the first network domain is ephemeral thereby avoiding permanent storage of the response data in the first network domain.

The first processing means may be a processor or code applied to a processor located on the user terminal.

The second processing means may be a processor, or code located in an existing processor at the second network domain.

The response data may be held permanently in the second network domain in a data store, or may be accessed via a data centre accessible by the second network domain.

For example, the cross-network domain Calendar system may comprise a user interface located at a first network domain configured for making a data request to access Calendar data contained in a data store located at a second network domain,
a processor located at the second network domain for receiving the data request, retrieving the data from the data store and transferring it across a network domain boundary as response data for receipt in the first network domain;

a user display interface located at the first network domain for displaying or otherwise representing the response data, wherein the response data at the first network domain is ephemeral thereby avoiding permanent storage of the response data in the first network domain.

The ‘otherwise alerting receipt’, may, for example, be an alternative means of visually representing the response data or alerting the fact data from the lesser trusted domain is present e,g, via an audio alert provided by a buzzer, or a tactile feedback alert such as a vibrate feature. The audio, visual and tactile alerts may be used independently or in a complementary way. The user may wish to select the ability to view data information from their (the second) network domain solely, they may select the data from the first network domain solely, or may select the data from both network domains to be accessed, and combined. The preferred alert option may depend on the type of compute device.

In each case there may be allocated an indicator in the form of a tailored screen setting that can be associated with each of the data options. For example, given the user alert parameters may be selected by the user, in one embodiment the visual parameters can be chosen and a value of the chosen visual parameter modified during independent or concurrent displaying of the content data by interaction with the graphical user interface to enable the content data to be dynamically formatted and displayed according to the modified value of the chosen visual parameter chosen and a value of the chosen visual parameter modified during independent or concurrent displaying of the content data by interaction with the graphical user interface to enable the content data to be dynamically formatted and displayed according to the modified value of the chosen visual parameter.

A particular font type or other preferred typographic or other graphic design feature may provide the visual alert. In one example the indicator may be in the form of a change in colour format of the screen background, or the particular font type or other preferred typographic or graphic design features to help the user instantly identify the response data type. As an example of the variable screen background embodiment, a calendar view powered by data from the second domain only may be displayed with a green background, a calendar view powered by data from both the first and second network domain may be displayed with a red background and a calendar view powered by data from the first domain only may be displayed with a blue background.

The system may further comprise a network domain gateway device located between the first network domain and the second network domain and configured to enable data transfer therebetween.

The system may further comprise the network gateway being a hardware device. As mentioned above, this provides simple yet reliable devices that can be located on the site of the e.g., trusted network domain.

The system may further comprise a permissions processor located at the second network domain configured to compare the user data request to permitted criteria for a given user prior to retrieving the data.

The system may further comprise a redaction processor in the second network domain configured to redact information retrieved in dependence upon the disclosure criteria. The redaction processor may be located in the disclosure module and acts a safety net to catch erroneous data transfer before it occurs.

The system may further comprise an Extract, Transform and Load (ETL) tool configured to be a data endpoint in the first network domain and configured to be a data endpoint in the second domain.

The ETL tool may be configured to perform an Identity substitution step whereby the user identity in the first network domain being transformed to a user identity in the second network domain or the user identity in the second network domain being transformed to a user identity in the first network domain. This can be useful to remove contextual information regarding the response data.

“Calendar event” may be considered an appointment, a meeting, or other interchangeable dictionary terminology as appropriate.

“Trusted network” means a business or other organisation's network that is under the control of a network manager or network administrator and which functions within security parameters to form a security perimeter. The trusted network is the destination of the electronic information e.g. file or streamed data.

“Lesser trusted network” means a network that is deemed untrusted or of unknown trust which lies outside of the security perimeter of the business or other organisation.

“Remote Agent” is used, to help distinguish its role from that of any other web service. However, fundamentally, the Remote Agent is a web service (that just happens to exist in a remote domain and therefore can't be directly accessed by the local user terminal/client).

Whilst the invention has been described above it extends to any inventive combination of the features set out above, or in the following description, drawings or claims. For example, any features described in relation to any one aspect of the invention is understood to be disclosed also in relation to any other aspect of the invention.

The invention will now be described, by way of example only, with reference to the accompanying drawings, in which:

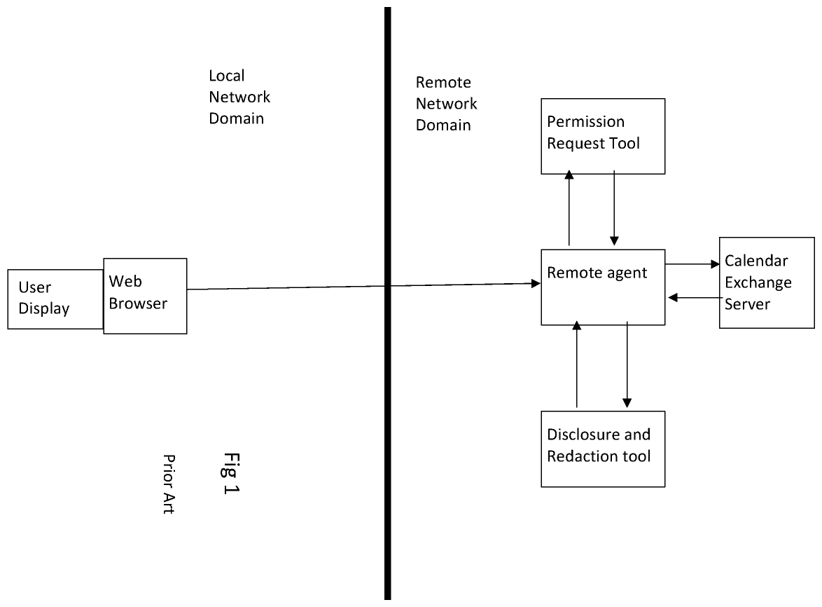

FIG. 1 is a schematic of a prior art system whereby the stored data is synced to ensure the stored calendar information on the remote network domain is mirrored by the stored calendar information on the local network domain;

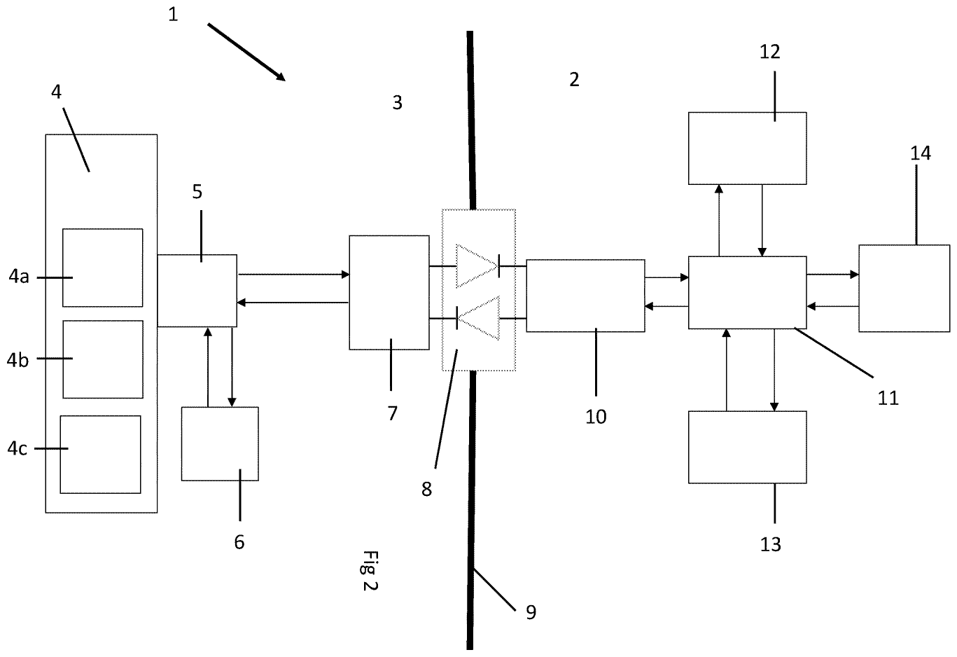

FIG. 2 shows the system in accordance with an embodiment of the invention; and

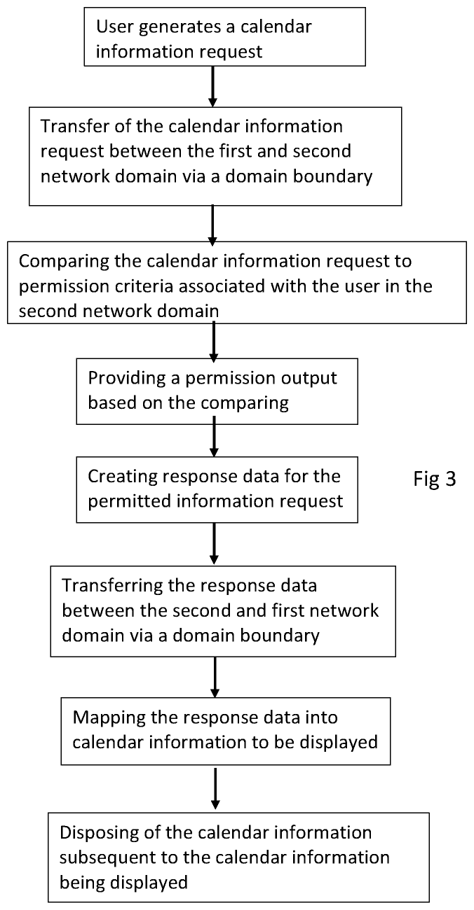

FIG. 3 shows a method in accordance with an embodiment of the invention.

In the Figures like elements are denoted by like reference numerals.

The skilled reader will appreciate how complex the implementation of the method is, and thus the number of the optional features present, will be driven by the user requirements.

Referring to FIG. 1, there is shown a prior art system whereby the user is able to directly access the calendar information data, it is typical for a sync and store operation to be applied whereby the calendar information on the remote network domain is mirrored on the local network domain.

FIG. 2 shows a first embodiment of the invention where there is provided a cross network domain calendar request system 1 that accesses calendar information from a high security domain 2 and pulls it back to a low security domain 3 where it is displayed. Given the invention could also operate to access calendar information from a low security domain to a high security domain, or indeed security domains of the same trust level having different security managers, the following embodiment of the invention discloses the invention by means of a local network domain and a remote network domain.

In a local network domain 3, a local user terminal 4 is communicatively coupled to a user client 5 (e. g having access to a HTTP web server 6). The user client 5 is communicatively coupled to a local target endpoint 7 (which is the last data location in the local network domain). One part of the local target endpoint 7 is communicatively coupled to a first end of a hardware gateway device 8 located at a network domain boundary 9. The hardware gateway device 8 is configured to permit the passage of data from the local network domain 3 to the remote network domain 2 by implementing a first data diode for permitting the data to pass along the data pathway in a single direction only—also known as a unidirectional gateway. This means that a data request can be passed along the diode. A second data diode is applied to pass data in the opposite direction to the first (to enable passage of any data response). An example hardware gateway device 8 may be found in the granted application GB2557010. The other end of the gateway device is communicatively coupled to a remote target endpoint 10 located in the remote network domain. This remote target endpoint 10 functions in the same way as the corresponding device in the local network domain 3, therefore the remote target endpoint 10 offers the last data location in the remote network domain 2.

There are various ETL tools available, but in this embodiment the local target endpoint 7 and the remote target endpoint 10 are provided by APACHE NIFI, which is an open-source process modeller configured to process and distribute data, particularly data that is to be transferred between systems via a hardware gateway. NIFI, is also configured to provide the identity mapping between the local network domain 3 and remote network domain 2. The effective load-spreading and high transaction rates lend NIFI well to this application, along with the option for users to write their own software to extend its abilities and to implement security using preferred encryption techniques.

The remote target endpoint 10 is communicatively coupled to a Remote Agent 11 that acts as a service hub. The Remote Agent 11 is communicatively coupled to a permissions module 12, a disclosure module 13 and a calendar exchange server 14 (the latter being communicatively separated from the permissions module 12 and the disclosure module 13 via the Remote Agent 11). This arrangement enables the Remote Agent 11 to refer requests to the permissions module 12 and the disclosure module 13 as required, and to receive the outputs after the processing of those requests prior to or subsequent to data exchange with the calendar exchange server 14. For example, when sending the calendar information request the Remote Agent 11 is configured to refer the request data to the permission module 12 that comprises a permission database so as to make sure that the correct access permissions are applied prior to forwarding the Calendar information request to the calendar exchange server 14.

On receipt of the data response from the calendar exchange server 14, the disclosure module 13 is called by the Remote Agent 11 so that consideration is given to the response data received from the calendar exchange server 14 and such that the relevant permissions and associated redactions are applied to the raw response data. This step provides a ‘safety net’ in the form of a final check to the data to be forwarded to the local user located at the local network domain 2 who is the requester of the calendar information, ensuring that only appropriate data is passed to the user for display e.g. via a screen. The resulting output from the Remote Agent 11 is the calendar information response. The Remote agent 11, the permissions module 12 and the disclosure module 13 are all processors with software rules configured to coordinate the data flow and checks, identify the permissions associated with a given user and to redact any erroneous information respectively.

In use, the electronic calendar information request is made by the user so that the user can access and display the calendar information on the local device in the local network domain 3 e.g. via an electronic user display 4b such as a screen. In this example, the user requires calendar information relating to a selected date and time period as they have a private appointment that they would like to schedule. The user located at a local network domain 3 (in this embodiment a low security domain) operates a local device and requests access to calendar information that is stored and managed from a remote network domain 2 (in this embodiment considered to be a high security domain).

The user creates the calendar information request via a user interface located at a local user terminal 4 by implementing a web service request e.g. HTTP REST API.

A local user identity validation step is undertaken by a user validation service e.g. Office 365 or Amazon active directory, or other suitable IdAM (or user client) in the local network domain 3 prior to the user request being passed to a local target endpoint 7 in the local network domain. At the local target endpoint 7 the calendar information request is transformed from the local format to a format that has desired data transfer properties e.g. the SISL format which is designed to be able to accurately and reliably represent structured files in a way that is easy to check for syntactic validity and as a strong way to protect against binary malware appearing to be valid SISL. Such SISL files can be easily spliced at the local network domain 3, transported across the network domain boundary 9 and recombined in the remote network domain 2. Examples of such structured data that can be represented in SISL includes XML, JSON and CSV. In this particular embodiment JSON is used.

It is the local target endpoint 7 that provides real-time control that optimises the transfer of data between the local network domain 3 and the remote network domain 2. As mentioned previously a suitable open source ETL tool, and the one used in this embodiment of the invention is Apache NIFI.

The calendar information request in the SISL format is then passed across a network domain boundary 9 that separates the local network domain 3 from the remote network domain 2. This transfer occurs via the cross-domain hardware gateway device 8.

The user request is then passed to a remote target endpoint 10 which translates the request back from the SISL file format to a native request format suitable for data handling in the remote network domain 2, in this example the SISL data format gets turned back into a HTTP API request with a JSON body. It is also at this step in the system where required, that there may be the mapping of the identity of the user i.e. they may have an identifier in the local network domain 3 that maps to a different identifier in the remote network domain 2. As an example, the user may be represented by a number in the local network domain 3 and may be represented by the person's name in the remote network domain 2, although other types of identifier may be used as desired and set by the management controller. Importantly, it isn't just the identity of the requester that can be obfuscated, instead the identity of the requested attendees, or other meeting participants may also undergo the transformation of identity information. This may be particularly important in a medical appointment system to protect private information about a medical appointment, whereby the full details of the appointment might be held on the remote (protected) system but externally the only thing that needs to be known is that there is an appointment and the location of that appointment, not exactly what procedures are to be undertaken or who would be the medical professional to be met—that information would remain within the remote (protective) network domain 2. This is particularly important where the consultant may be well known in a particular medical field and the patient may not wish for information relating to their diagnosis to be accessible or known by others. In this scenario the ability to obfuscate the consultant information on the local network domain 3 is necessary. Therefore, this mapping of ID data can be useful to provide anonymity of the user in the local network domain 3 and/or remote network domain 2 and may also protect the identity of other parties associated with the calendar entry.

Once the calendar information request is in the correct format and the identity information has been mapped as deemed required, the calendar information request is then passed to a Remote Agent 11 that acts as the service hub of the remote network domain 2. The Remote Agent is a web service, capable of handling HTTP/S requests from the Cross-Domain Hardware Gateway Device 8, for example the XCal event service.

Once received by the Remote Agent 11 user access checks are undertaken.

The Remote Agent calls the permission request tool located in the permissions module 12 which specifies the ID and access level information of a given identity on the remote network domain 2. By passing the remote identity information to the permission request tool the Remote Agent 11 is configured to receive information on whether the user is an authorised requester by establishing who they are and what information should be passed to them, if any at all. In the case the ID mapping is set up for both the requesting and the requested identity then the permissions check can be based both on the requesting and requested party.

The permission data is a database of permitted requests for a remote network domain 2 identity. The database is managed at the remote network domain 2 and may be modified and updated by a calendar permission manager. As an additional layer of functionality, the individual users located at the remote network domain 2 can provide permissions with respect to who across the network domain boundary has the right to view their calendar information and the level of associated information that the requester can gain.

For example, the network domain manager will set the upper/maximum threshold of what information is permitted to be accessed by a requester that is located outside of their primary network domain i.e. the requester is located at the local network domain 3. In addition to this, users can restrict what they would like to share. In consideration of these two permission layers, a predetermined attribution level per requester is provided. In the case of low attribution (due to the requester being in a lower trust network which in this example is the local network domain 3) the response will be limited to appropriately redacted information that is useful to genuine meeting attendees, particularly when compared to the known free/busy statement. So this system ensures the appropriate ‘richness of data’ and not elimination of ‘all useful data’. Although, if no permission is provided, a blank blocked out appointment is displayed, or the standard free/busy statement may be displayed depending on the preferred option, or indeed a statement suggestion that the requester does not have the appropriate permissions to access the requested data may be displayed. The latter may be useful for those that should have the relevant access, because this notice allows them to contact the security access manager to correct the access error by updating the permissions on the remote network domain 2.

The output from the permission request tool will determine whether or not the request is to be forwarded to the remote calendar server (calendar exchange) 14.

There is no requirement for the external recipient (the user) to have an account/an identity on the server that has been located in the protected network. Therefore, the permissions engine can give the user rights to see information for the purposes of scheduling/Managing without the need for the user to have accounts in both the local network domain 3 and remote network domain 2 systems.

In the case that the user located at the local network domain 3 is permitted to access the Calendar information requested, a data pathway is created between the remote agent service 11 and the Remote Calendar server 14 located in the remote network domain 4 and the remote agent 11 retrieves the relevant calendar information in order to create a calendar response to the calendar request made by the requester. The calendar information is obtained from a web calendar (not shown) located at the remote network domain 2.

The Calendar response, which includes the calendar information, is therefore sent to the Remote Agent 11. At this point the Remote Agent 11 calls the disclosure module 13 and the calendar information response is compared to a set of disclosure rules and undertakes redaction of any data that fails to meet the disclosure rules. For example, redaction of the subject matter of the meeting may be desired e.g. this may be the case when a consultant has a meeting to discuss a particular diagnosis of the patient, that the admin staff do not need to have the subject matter details of.

Keeping the information to a minimum, yet providing enough to be useful for the user at the local domain is the key to the effective running of the cross domain calendar of the current invention.

In a further example, the disclosure rule module 13 identifies whether there is any information associated with the calendar entry that should be removed prior to forwarding the response, or whether detailed or more limited information should be applied. For example, the location of a meeting is only required by the attendees, and is not information required by someone looking to identify a date for an alternative meeting to be arranged with the same health care provider. The location of a meeting may be mapped to a different format than would ordinarily be displayed if the calendar was requested on the remote network domain 2. Or indeed the location entry may be provided with more information if the attendee is unfamiliar with the location of the e.g. meeting/appointment. These disclosure rules may therefore comprise any ‘redaction rules’ that are to be followed e.g. the diagnosis example or location. Given the disclosure rules are reviewed each time the data is requested then where the rules have changed since the previous request by a user, a different snap-shot of calendar information may be presented, yet the previous request data will not have persisted and therefore the risk of incorrect meeting/appointment information is minimised. Importantly, so too is the risk of data mining minimised.

There is also the aspect of the user identities being translated to their local network equivalents (if that data is permitted to be passed by the permissions module) to avoid unnecessary disclosure of additional identity data (i.e. it shouldn't be possible to see the remote domain identifiers on the local network domain 3, just their local network domain identifiers).

When the disclosure rules are verified as being met, then the calendar information response is passed to the remote target endpoint 11 located in the remote network domain 2, where the data is transformed into a format that is suitable for passage across the hardware gateway device 8 e.g. SISL (as per the process described above). Subsequent to the data format transformation the converted data undergoes a final check so as to verify the reasonableness of the output by checking the response data structurally and syntactically (again in this embodiment this step occurs via the implementation of APACHE NIFI). Once this final check is passed, the response data is signed for export. Given the steps prior to this export signature, it is clear that the sign-off is in dependence upon the most current release control service. The remote target point then forwards the calendar response across the network domain boundary 9 back through the gateway device, this time through a data diode to form a unidirectional pathway that permits data to pass between the remote network domain 2 to the local network domain 3 only.

The data is received in the local network domain 3 by the local target endpoint 7 and the SISL data is mapped back to the data format that is native to the local network domain (in this example JSON). In this embodiment additional security controls are employed by the transfer mechanism (e.g. checking the security labelling of the data (Xep-258/259) to prevent inappropriate disclosure of material too sensitive for the local network domain) which happen transparently to the API request (if a violation is detected, the API request fails with the error obfuscated to deter malicious trial-and-error attacks).

Given the local target endpoint 7 awaits the response to its request, as soon as that calendar information response passes through the hardware gateway device 8 and is transformed to the correct format to be handled by the local network domain 3, the calendar information response is forwarded to the local client without further validation as to the identity of the user who made the request, where it is then transferred to the local user terminal 4. The calendar information response is then mapped to a format to be displayed on an electronic user display 4b e.g. the screen of the local user terminal 4.

Importantly response data is not stored in e.g. a database outside of its home security location i.e. the local network domain 3—it is only a transient view that is re-evaluated each time a request by a user is made therefore the period for which there is any risk to the data only lasts while the information is being viewed. That is to say that the calendar information response is ephemeral, which means it is only available for the length of time that the data is displayed to the user on the electronic user display 4b screen of the local user terminal or device 4. So whilst the calendar information response data may be held in RAM for the period of time that the calendar information is displayed, it is never stored permanently or at rest. This means that as soon as the calendar display is refreshed, the data is gone and further requests would be required to access and display the Calendar information. There is no synchronisation of the calendar information data located on the local network domain 3 with the remote network domain 2. The data is only transferred and accessed by the electronic user display 4b e.g. screen of the local device at the instant it is viewed. This provides an additional level of protection, because the data is only located outside of its primary security domain for the short period of time the user views the data. Meaning any malicious actors would need to know when the data is to be accessed by the user to attempt to access it.

Additionally, the period over which data is viewable in the local network domain 3 is controlled at the remote network domain 2 and whilst it is configurable, it is aligned with internal policy at the trusted network. By limiting the time of access to the data that has been transferred from the remote network domain 2 and the local network domain 3, and avoiding the permanent storage of unnecessary data outside of the primary security domain (i.e. the remote network domain), the possibility of data trawling is eliminated.

Each time a calendar information request is made, the security control criteria relating to the viewing of and transfer of that data is evaluated. This means that the security policy is adhered to on every Calendar request and for every time the response data is viewed by the user in the local network domain 3, and ensures that the data that is sent to the user's local network domain 3 always follows the most up to date security policy. This limits the risk of data aggregation outside of the data's home security domain, which can be particularly problematic when that data does not comply with the most up to date data security policy.

The number of requests from an individual are rate limited to allow for normal non-machine requests only. For example, known machine learning techniques can be used to identify and tailor the number of requests of a user and to amend the permissions automatically if desired. A suitable request rate would be three queries per hour, and this can be increased if the likelihood of more requests is greater given the role of a requester e.g. a Personal Assistant who sets up the meetings for others as a core part of his/her role.

Further to controlling the time period of display of the response data, the time window of what is potentially viewable to a user request may change dependent upon the attribution/identity of the user. For example, only an ability to access a three month period of Calendar information will be required for most requesters, but when the Calendar of Seniors are to be viewed there may be a need to view a longer period, e.g. a twelve month period. A strict rule in this regard may in fact be detrimental as it could in itself enable data/identity mining which is preferably to be avoided.

To aid the system, explicit permit lists for meeting subjects, well-known events such as catch-ups, follow-on appointments e.g. Physio or coffees may be applied. Any non-permitted listed meeting subjects will be redacted as described previously. Accompanying standard labels can also be applied.

It is important to send the data request without any contextual information to ensure that any data extraction cannot be used to access information on the meeting attendees. Data transfer will be repeated many times compared to other calendar management systems.

Various modifications to the principles described above would suggest themselves to the skilled person. For example, in an alternative embodiment of the invention the user is located in a high security domain and requests calendar information from a low security domain.

Either the trusted network or the lesser trusted network can be considered the home security domain and similarly, either the trusted network or the lesser trusted network can be considered the foreign security domain.

At the request stage instead of the HTTP REST API other alternatives may be applied e.g. HTTPS, Caldav as the transport protocol or GraphQL, or even a web socket request or other defined standard way of making an API call may be implemented.

Whilst this invention is of particular use when accessing calendar information across domains of differing trust, it is also to connect different devices that located on different network domains, but have the same level of trust, but different security managers. In a yet alternative embodiment of the system and particularly where the first and second network domain have the same trust level, there is no requirement for identity mapping step to be performed. In an alternative embodiment the two private networks may be directly linked together without the need for a bi-unidirectional gateway to be implemented. The linking of the two network domains together explicitly requires a direct trust relationship.

As an alternative to a hardware gateway, a software gateway may be implemented so as to provide the same level of control across the network domain boundary.

In an alternative embodiment the ID substitution or mapping can be undertaken anywhere in the remote network domain 2 and it may not occur at the remote target endpoint 10. For example, the identity mapping may occur at the service processor of the remote agent 11 or at a redaction processor in the disclosure module 12. In all instances any identity mapping will be dependent upon predetermined identity rules.

In an alternative embodiment of the invention, the security protective marking mechanism is not provided by the gateway device 8, but may be provided by other means that are outside the scope of the invention. In a further embodiment, the security protective marking mechanism are not implemented and as such are not considered to be an essential feature of this invention, although may be a desirable one.

Ultimately the system enables the safe viewing of calendar information across network security boundaries, because the data does not exist after the data has been displayed and refreshed. Further the regularity of calendar updates is of no concern because each time a calendar information request is made, the request is compared to pre-determined criteria, reviewed, updated and constrained where required-meaning that the user always has access to the current data. This ensures that the data is never stale, and that the system can recover gracefully from typical gateway outages/issues and that the security criteria is always up to date.

Finally, there is no requirement to sync stored Calendar data on the local network domain 3 to match that contained in the remote network domain 2. This beneficially alleviates the need for the user located at the local network domain 3 to have an account on both systems i.e. in both network domains.

1. A method for accessing calendar information located across a network domain boundary (9) separating a first network domain (3) and second network domain (2), comprising:
a user creating enquiry data at the first network domain (3) and transferring the enquiry data between the first network domain (3) and the second network domain (2) to provide a user data request;
comparing the user data request to permission criteria relating to the user in the second network domain (2) to determine whether at least part of the permission criteria is met;
based on the comparing, retrieving response data from a data storage area located in the second network domain (2);
subsequently transferring the response data between the second network domain (2) and the first network domain (3); and
displaying or otherwise alerting receipt of the response data by the user located at the first network domain (3), wherein any response data received by the user located at the first network domain (3) is ephemeral.

2. The method according to claim 1, wherein the response data is held in Random Access Memory (RAM) (4c) and is marked as being reclaimable once the response data ceases to be displayed to the user in the first network domain (3).

3. The method according to claim 1, further comprising electronically mapping the response data into calendar information to be displayed or otherwise received by the user located at the first network domain (3).

4. The method according to claim 1, wherein the calendar information is displayed on a user display (4b) an act of refreshing the user display (4b) triggers the calendar information to be cleared.

5. The method according to claim 1, wherein response data is retrieved only for the part of the user data request where the permission criteria is met.

6. The method according to claim 1, wherein the part of the user data request where the permission criteria has not been met is discarded or otherwise ignored.

7. The method according claim 1, wherein either the first network domain (3) is a trusted network domain and the second network domain (2) is a lesser trusted network domain or the first network domain (3) is a lesser trusted network domain and the second network domain (2) is the trusted network domain, or the first network domain (3) and the second network domain (2) have the same level of trust.

8. The method according to claim 1, wherein the first network domain (3) and the second network domain (2) have separate and distinct security management criteria.

9. The method according to claim 1, further comprising response data solely being transferred between the second network domain (2) and the first network domain (3) upon a calendar information request by the user located at the first network domain (3).

10. The method according to claim 1, further comprising collating the response data associated with the second network domain (2) with calendar data stored on the first network domain (3) to provide a single calendar display comprising both event entries from the first network domain (3) and the second network domain (2).

11. The method according to claim 1, further comprising redacting at least part of the response data in dependence upon pre-determined disclosure criteria.

12. The method according to claim 1, wherein user identifier information is mapped from a first network domain identifier to a second network domain identifier and/or from a second network domain identifier to a first network domain identifier.

13. The method according to claim 1, wherein the enquiry data and the user data request comprises a stream of data comprising data packets.

14. The method according to claim 1, wherein the response data comprises a stream of data comprising data packets.

15. The method according to claim 1, wherein the enquiry data and/or the response data is transferred across the network domain boundary (9) via a network gateway device (8).

16. The method according to claim 1, wherein the enquiry data is transformed from the first network domain data format to a SISL data structure prior to being passed across the network domain boundary (9).

17. The method according to claim 1, wherein the response data is transferred from a file format of the second network domain (2) to a SISL data structure prior to crossing the network domain boundary (9).

18. The method according to claim 16, wherein the first network domain data format and/or the second network domain data format is JSON, XML or CSV.

19. The method according to claim 1, wherein the response data transferred between the second network domain (2) and the first network domain (3) data or between the first network domain (2) and the second network domain (3) is devoid of contextual information.

20. The method according to claim 1, wherein the transfer of enquiry data from a user is rate limited dependent upon an identity of the user.

21. A cross network domain data system for use with a user terminal (4), having a user display (4b), the user terminal being located at a first network domain (3) comprising:
a first processing means (5) located at the first network domain (3) configured to, in use, generate a user data request to access data located at a second network domain (2),
a second processing means (11) located at the second network domain (2) and configured to receive the user data request, retrieve response data and transfer the response data across a network domain boundary (9) for receipt in the first network domain, such that the response data is displayed or otherwise represented via the user display (4b), wherein the response data at the first network domain (3) is ephemeral.

22. The system according to claim 21, further comprising a network gateway device (8) located between the first network domain (3) and the second network domain (2) and configured to enable data transfer therebetween.

23. The system according to claim 22, wherein the network gateway device (8) is a hardware device.

24. The system according to claim 21 further comprising a permissions processor (12) located at the second network domain (2) configured to compare the user data request to predetermined permission criteria for a given user prior to retrieving the response data.

25. The system according to claim 21 further comprising a redaction processor (13) in the second network domain (2) configured to redact information retrieved in dependence upon predetermined disclosure criteria.

26. The system according to claim 21 further comprising an Extract, Transform and Load (ETL) tool to be a local data target endpoint for data in the first network domain (3) and a remote data target endpoint for data in the second domain (2).

27. The system according to claim 26, wherein the Extract, Transform and Load (ETL) tool is configured to perform an Identity substitution step whereby a first user identity in the first network domain (3) is transformed to a second user identity in the second network domain (2) or the second user identity in the second network domain (2) is transformed to the first user identity in the first network domain (3).
